(19) United States
(12) Patent Application Publication
(10) Pub. No.: US 2012/0096255 A1
(43) Pub. Date: Apr. 19, 2012

(54) SERVER AND METHOD FOR MANAGING I2C BUS OF THE SERVER

(75) Inventor: YU-GANG ZHANG, Shenzhen City (CN)

(73) Assignees: HON HAI PRECISION INDUSTRY CO., LTD., Tu-Cheng (TW); HONG HU JIN PRECISION INDUSTRY (ShenZhen) CO., LTD, ShenZhen City (CN)

(21) Appl. No.: 13/204,720

(22) Filed: Aug. 8, 2011

(30) Foreign Application Priority Data
Oct. 13, 2010 (CN) 201010505757.8

(51) Int. Cl. G06F 15/177

(52) U.S. Cl. 713/2

(57) ABSTRACT

In a method for managing an inter-integrated circuit (I2C) bus of a server, a bus flag is set for the I2C bus using a BMC. When the BMC requires to detect a temperature of a memory of the server, the temperature is detected by accessing a SPD chip of the server through the I2C bus if a value of the bus flag is a first value. The value of the bus flag is changed to a second value when the memory requires to be initialized by a BIOS, and a delay for a predetermined time period occurs. Configuration information of the memory is acquired by the BIOS from the SPD chip through the I2C bus when the predetermined time period is elapsed, and the memory is initialized by the BIOS according to the configuration information. The value is reset to the first value after the memory is initialized.

### BACKGROUND

1. Technical Field

Embodiments of the present disclosure relate generally to bus management of servers, and more particularly, to a server and a method for managing an inter-integrated circuit (I2C) bus of the server.

2. Description of Related Art

Serial presence detect (SPD) chips may be used to store configuration information of memories of a server. The configuration information may include timing parameters, manufacturers, serial numbers, temperatures, capacities, operating voltages, and other useful information about the memories. When a memory is to be initialized, a basic input output system (BIOS) may access the configuration information from the SPD chip using an I2C bus of the server. In addition, a baseboard management controller (BMC) of the server may monitor a temperature of the memory by accessing the SPD chip through the I2C bus. When the BIOS and the BMC simultaneously access the SPD, a conflict between the BIOS and the BMC may happen, which may cause the server to fail.

### BRIEF DESCRIPTION OF THE DRAWINGS

FIG. 1 is a block diagram of one embodiment of a server including a baseboard management controller (BMC) and a basic input output system (BIOS).

FIG. 2 is a flowchart of one embodiment of a method for managing an I2C bus implemented by the BMC included in the server of FIG. 1.

FIG. 3 is a flowchart of one embodiment of the method for managing the I2C bus implemented by the BIOS included in the server of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

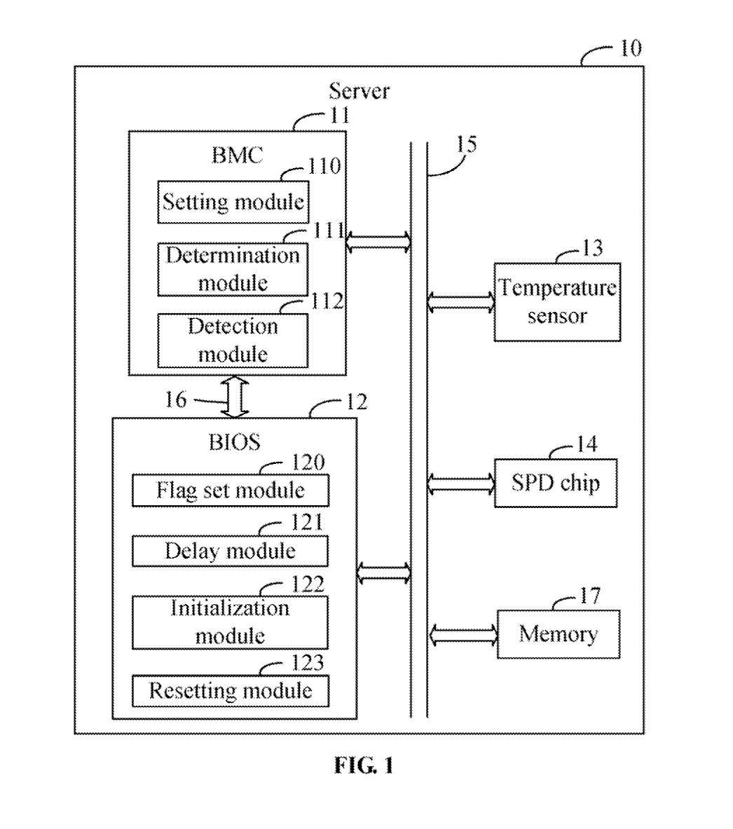

FIG. 1 is a block diagram of one embodiment of a server 1 including a baseboard management controller (BMC) 11 and a basic input output system (BIOS 12). In the embodiment, the server 1 further includes a temperature sensor 13, a serial presence detect (SPD) chip 14, an inter-integrated circuit (I2C) BUS 15, a communication bus 16, and a memory 17. The BMC 11 and the BIOS 12 may access the SPD chip 14 through the I2C bus 15. The BMC 11 communicates with the BIOS 12 through the communication bus 16. The communication bus 16 may be, for example, a low pin count (LPC) bus. It should be apparent that FIG. 1 is only one example of the server 1 that can be included with more or fewer components than shown in other embodiments, or a different configuration of the various components.

The temperature sensor 13 is operable to detect a temperature of the memory 17, and store the detected temperature in the SPD chip 14. The temperature may be accessed from the SPD chip 14 by the BMC 11 and the BIOS 12 through the I2C bus 15. The SPD chip 14 stores other configuration information, such as, timing parameters, the manufacturer, serial numbers, capacities, and an operating voltage of the memory 17. The configuration information may be accessed by the BIOS 12 when the memory 17 requires to be initialized. If the BIOS 12 and the BMC 11 simultaneously access the SPD chip 14, a conflict of using the I2C bus between the BIOS and the BMC may happen.

In one embodiment, the BMC 11 includes a setting module 110, a determination module 111, and a detection module 112. In general, the word “module”, as used herein, refers to logic embodied in hardware or firmware, or to a collection of software instructions, written in a programming language, such as, Java, C, or Assembly. One or more software instructions in the modules may be embedded in firmware, such as in an EPROM. The modules described herein may be implemented as either software and/or hardware modules and may be stored in any type of computer-readable medium or other storage device. It should be understood that the modules 110-112 may comprise computerized instructions in the form of one or more programs that are stored in a storage medium of the BMC 11, and executed by a microprocessor of the BMC 11 to provide functions of the BMC 11. The storage medium and the microprocessor of the BMC 11 are not shown in FIG. 1.

The setting module 110 is operable to set a bus flag for the I2C bus 15. In one embodiment, a value of the bus flag may be initialized as a first value, such as “0”, when the server 1 is powered on. In the embodiment, when the value of the bus flag is set to the first value, the I2C bus 15 cannot be used by the BIOS 12. For the BIOS 12 to access the SPD chip 14 through the I2C bus 15, the value of bus flag needs to be changed to a second value by the BIOS 12, such as “1”. The bus flag may be stored in an internal register of the BMC 11.

The determination module 111 is operable to determine whether a value of the bus flag is the first value when the BMC 11 requires to detect a temperature of the memory 17. In one embodiment, if the value is not the first value, it denotes that the BIOS 12 is reading/writing data using the I2C bus, such as accessing the SPD chip 14 for acquiring configuration information of the memory 17 through the I2C bus, and the value of the bus flag has been changed to the second value by the BIOS 12.

The detection module 112 is operable to detect the temperature of the memory 17 by accessing the SPD chip 14 through the I2C bus, if the value of the bus flag is the first value. In one embodiment, if the value of the bus flag is not the first value, the detection module 112 may detect the temperature when the value of the bus flag is reset to the first value by the BIOS 12, so a conflict between the BMC 11 and the BIOS 12 over use of the I2C bus can be avoided.

The BIOS 12 includes an flag set module 120, a delay module 121, an initialization module 122, and a resetting module 123. It should be understood that the modules 120-123 comprise computerized instructions in the form of one or more programs that are stored in a storage system of the server 1, and executed by a processor of the server 1 to provide functions of the server 1. The storage system and the processor of the server 1 are not shown in FIG. 1.

The flag set module 120 is operable to change the value of the bus flag to the second value to initialize the memory 17. In one embodiment, the flag set module 120 may change the value of the bus flag by sending a command to the BMC 11 through the communication bus 16. When the value of the bus flag is the second value, the BMC 11 cannot use the I2C bus until the value is reset to the first value.

The delay module 121 is operable to delay a predetermined time period. In the embodiment, the predetermined time period is greater than that the amount of time needed by the BMC 11 to detect the temperature of the memory 17 through the I2C bus 15. For example, if the BMC 11 requires 0.2 second to 0.3 second to perform the temperature check, the predetermined time period may be set to 0.5 seconds or more. Thus, the BIOS 12 and the BMC 11 will not simultaneously attempt to use the I2C bus 15, and avoid conflicts.

The initialization module 122 is operable to acquire configuration information of the memory by accessing the SPD chip 14 through the I2C bus when the predetermined time period is elapsed, and initialize the memory 17 according to the configuration information.

The resetting module 123 is operable to reset the value of the bus flag to the first value after the memory 17 is initialized.

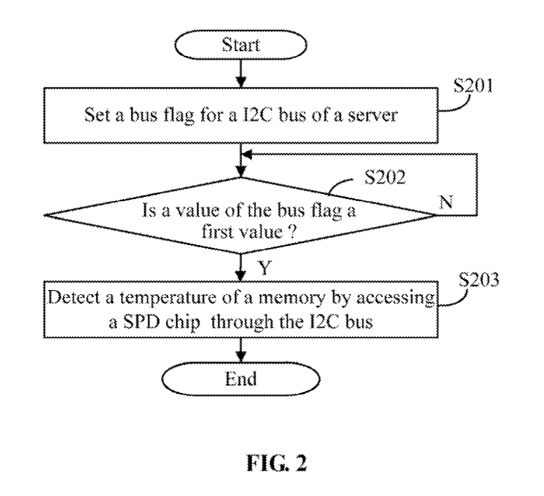

FIG. 2 is a flowchart of one embodiment of a method for managing an I2C bus 15 of the server 1 implemented by the BMC 11. Depending on the embodiment, additional blocks may be added, others removed, and the ordering of the blocks, may be changed.

In block S201, the setting module 110 sets a bus flag for the I2C bus 15. In one embodiment, a value of the bus flag may be initialized as a first value, such as “0”, when the server 1 is powered on. The value of bus flag may be changed to a second value by the BIOS 12, such as “1”, when the I2C bus is used by the BIOS 12. The bus flag may be stored in an internal register of the BMC 11.

In block S202, the determination module 111 determines whether a value of the bus flag is the first value when the BMC 11 requires to detect a temperature of the memory 17. If the value is not the first value, block S202 is repeated until the value of the bus flag is reset to the first value. Otherwise, if the value of the bus flag is the first value, block S203 is implemented. In the embodiment, if the value is not the first value, it denotes that the BIOS 12 is reading/writing data using the I2C bus, such as accessing the SPD chip 14 for acquiring configuration information of the memory 17 through the I2C bus, and the value of the bus flag has been changed to the second value by the BIOS 12.

In block S203, the detection module 112 detects the temperature of the memory 17 by accessing the SPD chip 14 through the I2C bus. In one embodiment, if the value of the bus flag is not the first value, the detection module 112 may detect the temperature after the value of the bus flag has been reset to the first value by the BIOS 12. Thus, conflicts over use of the I2C are avoided.

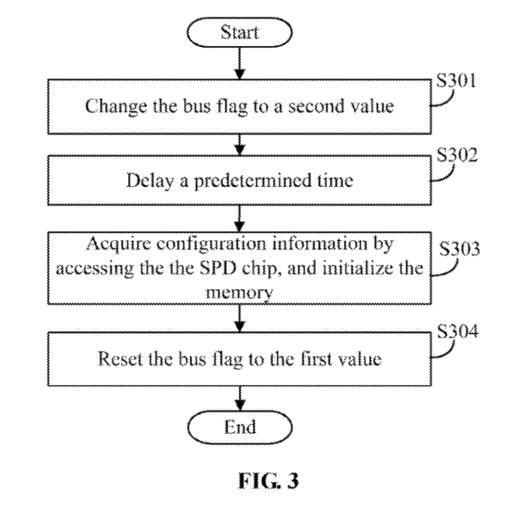

FIG. 3 is a flowchart of one embodiment of the method for managing the I2C bus 15 implemented by the BIOS 12.

In block S301, the flag set module 120 changes the value of the bus flag to the second value when the memory 17 requires to be initialized. In one embodiment, the flag set module 120 may change the value of the bus flag by sending a command to the BMC 11 through the communication bus 16. When the value of the bus flag is changed to the second value, the BMC 11 cannot use the I2C bus until the value is reset to the first value.

In block S302, the delay module 121 delays a predetermined time period. In the embodiment, the predetermined time period is greater than the time needed for the BMC 11 to detect the temperature of the memory 17 through the I2C bus 15. Thus, the BIOS 12 and the BMC 11 will not simultaneously attempt to use the I2C bus 15, and avoid conflicts.

In block S303, the initialization module 122 acquires configuration information of the memory by accessing the SPD chip 14 through the I2C bus when the predetermined time period is elapsed, and initializes the memory 17 according to the configuration information.

In block S304, the resetting module 123 resets the value of the bus flag to the first value after the memory 17 is initialized. After the value of the bus flag has been reset to the first value, the BMC 14 may access the SPD chip through the I2C bus.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. A method for managing an inter-integrated circuit (I2C) bus of a server, the method comprising:
implementing steps (a) to (c) using a baseboard management controller (BMC) of the server;
(a) setting a bus flag for the I2C bus;
(b) determining whether a value of the bus flag is a first value when the BMC requires to detect a temperature of a memory of the server;
(c) detecting the temperature of the memory by accessing a serial presence detect (SPD) chip of the server through the I2C bus; and
implementing steps (d) to (g) using a basic input output system (BIOS) of the server;
(d) changing the value of the bus flag to a second value when the memory requires to be initialized;
(e) delaying a predetermined time period;
(f) acquiring configuration information of the memory by accessing the SPD chip through the I2C bus when the predetermined time period is elapsed, and initializing the memory according to the configuration information;
(g) resetting the value of the bus flag to the first value after the memory is initialized.

2. The method according to claim 1, wherein the value of the bus flag is initialized as the first value when the server is powered on.

3. The method according to claim 1, wherein the bus flag is stored in an internal register of the BMC.

4. The method according claim 3, wherein the BMC communicates with the BIOS through a low pin count bus (LPC) of the server.

5. The method according to claim 4, wherein the value of the bus flag is changed by sending a command to the BMC through the LPC bus.

6. The method according to claim 1, wherein the predetermined time period is greater than that the amount of time needed by the BMC to detect the temperature of the memory through the I2C bus.

7. The method according to claim 1, wherein the temperature of the memory is detected by a temperature sensor of the server, and is stored in the SPD chip.

8. A server, comprising:
an inter-integrated circuit (I2C) bus, a serial presence detect (SPD) chip, a memory, a baseboard management controller (BMC), and a basic input output system (BIOS);
the BMC comprising:
a setting module operable to set a bus flag for the I2C bus;
a determination module operable to determine whether a value of the bus flag is a first value when the BMC requires to detect a temperature of the memory; and
a detection module operable to detect the temperature of the memory by accessing the SPD chip through the I2C bus;
the BIOS comprising:
a flag set module operable to change the value of the bus flag to a second value when the memory requires to be initialized;
a delay module operable to delay a predetermined time period;
an initialization module operable to acquire configuration information of the memory by accessing the SPD chip through the I2C bus when the predetermined time period is elapsed, and initialize the memory according to the configuration information; and
a resetting module operable to reset the value of the bus flag to the first value after the memory is initialized.

9. The server according to claim 8, wherein the value of the bus flag is initialized as the first value when the server is powered on.

10. The server according to claim 8, wherein the bus flag is stored in an internal register of the BMC.

11. The server according claim 10, wherein the BMC communicates with the BIOS through a low pin count bus (LPC) of the server.

12. The server according to claim 11, wherein the value of the bus flag is changed by sending a command to the BMC through the LPC bus.

13. The server according to claim 8, wherein the predetermined time period is greater than that the amount of time needed by the BMC to detect the temperature of the memory through the I2C bus.

14. The server according to claim 8, wherein the temperature of the memory is detected by a temperature sensor of the server, and is stored in the SPD chip.
